(19) United States
(12) Patent Application Publication
(10) Pub. No.: US 2009/0300685 A1
(43) Pub. Date: Dec. 3, 2009

(54) SYSTEM, METHOD, AND DEVICE FOR TRANSMITTING VIDEO CAPTURED ON A WIRELESS DEVICE

(75) Inventor: Phillip J. Easter, Colorado Springs, CO (US)

Correspondence Address: KNOBBE MARTENS OLSON & BEAR LLP, 2040 MAIN STREET, FOURTEENTH FLOOR, IRVINE, CA, 92614, US

(73) Assignee: AirMe Inc., Colorado Springs, CO (US)

(21) Appl. No.: 12/130,759

(22) Filed: May 30, 2008

(51) Int. Cl. H04N 7/12

(52) U.S. Cl. 725/62

(57) ABSTRACT

Aspects include methods, systems, and apparatuses for processing video for display on a display device. The method may include receiving a plurality of video segments from a wireless device, wherein each video segment comprises video data captured by the wireless device; determining a data rate at which at least one of the plurality of video segments was received; determining a delay based at least in part on the data rate at which at least one of the plurality of video segments was received; waiting for a time approximately equivalent to the delay; and transmitting for display on the display device the video segments in substantially the same order as the video segments were received, wherein a size of the video segments is determined based on at least one capability of the wireless device, and wherein transmitting a first video segment is executed substantially simultaneously with or before receiving a last video segment. The method may also include storing the received plurality of video segments and concatenating the plurality of video into a single file capable of being displayed by the display device. Other aspects include methods, systems, and devices for transmitting video from a wireless device.

### BACKGROUND OF THE INVENTION

1. Field of the Invention

This application relates generally to the display of media, and more specifically to the transmission and display of media captured on a wireless device.

2. Description of the Related Art

Wireless devices, such as mobile telephones and certain personal organizers, may be configured to capture media such as images, audio, and/or video. In order for an individual who is remote from the user of the wireless device to view and/or hear the captured media, the wireless device user must transmit the captured media to another device accessible to that user, and which can display the captured media. Thus, a need exists for methods and devices for transmitting and displaying media captured on such wireless devices.

### SUMMARY OF EMBODIMENTS

One embodiment includes a method of transmitting video for display on a display device. The method includes receiving a plurality of video segments from a wireless device, wherein each video segment comprises video data captured by the wireless device; determining a data rate at which at least one of the plurality of video segments was received; determining a delay based at least in part on the data rate at which at least one of the plurality of video segments was received; waiting for a time approximately equivalent to the delay; and transmitting for display on the display device the video segments in substantially the same order as the video segments were received, wherein a size of the at least one video segment is determined based on at least one capability of the wireless device, and wherein transmitting a first video segment is executed while receiving or before receiving a last video segment.

Another embodiment includes a method of transmitting video for display on a display device. The method includes receiving a first video segment from a wireless device; transmitting for display on the display device the first video segment; receiving a second video segment from the wireless device before transmission of the first video segment is complete; and transmitting for display on the display device the second video segment following completion of transmission of the first video segment, wherein the first and second video segments comprise video data captured by the wireless device, wherein the size of the first video segment and the second video segment is determined based on at least one capability of the wireless device, and wherein less than all of the video data in the second video segment existed before the receiving of the first video segment is substantially complete.

Still another embodiment includes a method of transmitting video from a wireless device. The method includes determining a first video segment size based at least in part on a capability of the wireless device; capturing a first video segment by use of the wireless device, the first video segment being of a size approximately equivalent to the determined first video segment size; transmitting the first video segment to another device for display; capturing a second video segment by use of the wireless device substantially simultaneously with the transmission of the first video segment; and transmitting the second video segment to the other device for display following the transmission of the first video segment, wherein the first and second video segments comprise video data.

Yet another embodiment includes a system for transmitting video for display on a display device. The system includes means for receiving a plurality of video segments from a wireless device, wherein each video segment comprises video data captured by the wireless device; means for determining a data rate at which at least one of the plurality of video segments was received; means for determining a delay based at least in part on the data rate at which at least one of the plurality of video segments was received; and means for transmitting the video segments for display on the display device, after waiting for a time approximately equivalent to the delay, in substantially the same order as the video segments were received, wherein a size of the at least one video segment is determined based on at least one capability of the wireless device, and wherein the transmitting means is configured to transmit a first video segment while the receiving means is receiving or before the receiving means is receiving a last video segment.

Another embodiment includes a wireless device for transmitting video. The wireless device includes a determination module configured to determine a first video segment size based at least in part on a capability of the wireless device; a camera configured to capture video data; a memory configured to store at least a first video segment of a size approximately equivalent to the first video segment size, wherein the video segment comprises captured video data; a processor configured to store at least the first video segment and a second video segment obtained from captured video data in the memory; and a transmitter configured to transmit the first video segment from the memory for display on another device, and the second video segment from the memory following transmission of the first video segment, wherein the processor is further configured to store the second video segment in the memory while the transmitter is transmitting the first video segment.

### BRIEF DESCRIPTION OF THE DRAWINGS

FIG. 1 is a diagram illustrating an example system for capturing media on a wireless device and for transmitting the captured media for display on a display device.

FIG. 2 is a diagram illustrating the capture of media on a wireless device, such as illustrated in FIG. 1, and the transmission of the captured media for display on a display device, such as illustrated in FIG. 1.

FIG. 3 is a block diagram illustrating an example of a wireless device such as that illustrated in FIG. 1.

FIG. 4 is a block diagram illustrating an example of a server such as that illustrated in FIG. 1.

FIG. 5 is a block diagram further illustrating an example of a server such as that illustrated in FIG. 1.

FIG. 6 is a flowchart illustrating an example of a method for transmitting video segments from a wireless device such as that illustrated in FIG. 3.

FIG. 7 is a flowchart illustrating an example of a method for processing video segments at a server such as that illustrated in FIGS. 4 and 5.

FIG. 8 is a flowchart illustrating an example of a method for producing a complete video file at a concatenation database, such as may be contained in a server of the type illustrated in FIG. 4.

### DETAILED DESCRIPTION OF CERTAIN EMBODIMENTS

The following detailed description is directed to certain exemplary embodiments. There is a multitude of different ways, however, to implement such embodiments and aspects described in the embodiments. It should be apparent that any specific structure and/or function that is disclosed herein is merely representative. Those skilled in the art will realize that disclosed aspects may be omitted, isolated, or combined in various ways. For example, an apparatus may be implemented or a method may be practiced using other structure, functionality, or structure and functionality in addition to or other than one or more of the aspects described herein.

Many wireless devices are capable of capturing and storing media including images, audio, and/or video. The quality and size of the captured media is limited by the features of the wireless device, such as by the resolution of a camera contained in or attached to the wireless device and by the size of a memory contained in or attached to the wireless device. In some wireless devices, extra memory may be added, but the size of the memory is always finite.

Media captured and stored on a wireless device often may be displayed thereon for the user of the wireless device. In some situations, however, the user of the wireless device would like to share the captured media with other individuals. In these situations, the other individuals have typically been required to be in close proximity to the wireless device so as to be able to view and/or hear the captured media being displayed on the wireless device.

In some instances, it is possible to transmit the captured media to another device that is not in close proximity to the wireless device. In this way, the user may be able to share captured media with other individuals, sometimes across great distances. In addition, if the captured media is stored on the other device, then continued access to the media is possible even if the captured media is deleted from the wireless device. Such deletion makes space in the wireless device memory available for new media to be captured.

Transmission of the captured media from the wireless device to another device can be accomplished using a variety of methods. For example, the user may wirelessly transmit the captured media over a Bluetooth connection or by using a Multimedia Messaging Service. In some instances, the user of the wireless device may also be able to physically connect the wireless device to another device, such as by using an electrical cord. One typical electrical cord includes a USB interface.

These methods of transmitting captured media to another device are often cumbersome and inadequate. For example, many users are unfamiliar with these methods and find them difficult to learn. Of the users that are familiar with these methods, many often forget to transmit captured media until there is no unused memory left on the wireless device, thus preventing further storage of captured media. In this circumstance, it may not be possible to quickly free memory space by transmitting the captured media for reasons such as no receiving device is available to receive the media. Thus, users are forced to choose between deleting stored captured media and opting not to capture any new media. Additionally, users may not want to take the time to transmit the captured media stored on the wireless device, especially when there is a significant amount of stored captured media to be transmitted. A user may want to avoid losing the time required to transmit the captured media due to a time-sensitive nature of the captured media or merely because of the burdens such a time commitment would impose.

Some devices are capable of transmitting media as it is being captured. For example, live broadcasts of television programming utilize cameras and transmission equipment that can transmit media as it is being captured. These live broadcasts allow for the viewing of media as it is being recorded. Equipment used to transmit television programming, however, typically transmits media from the point of capture to the point of broadcast using microwave transmission. Most wireless devices are incapable of such transmission because they lack specialized hardware required to execute that transmission and because many networks over which wireless devices transmit do not operate at a speed that is sufficient to accommodate microwave transmission. Thus, the option of transmitting live media for remote viewing is unavailable to most wireless device users.

In one embodiment of the development disclosed herein, a first wireless device captures a video segment and transmits the video segment as another segment is being captured. In another embodiment, a second device receives video segments and transmits the segments for display on a display device. In yet another embodiment, a third device concatenates the video segments into a single file and saves the file. Thus, a first wireless device is described that does not require special hardware for transmitting live media, wherein the transmitting can be accomplished relatively independent of network speed, and a second device is described for transmitting for display media captured on the first wireless device.

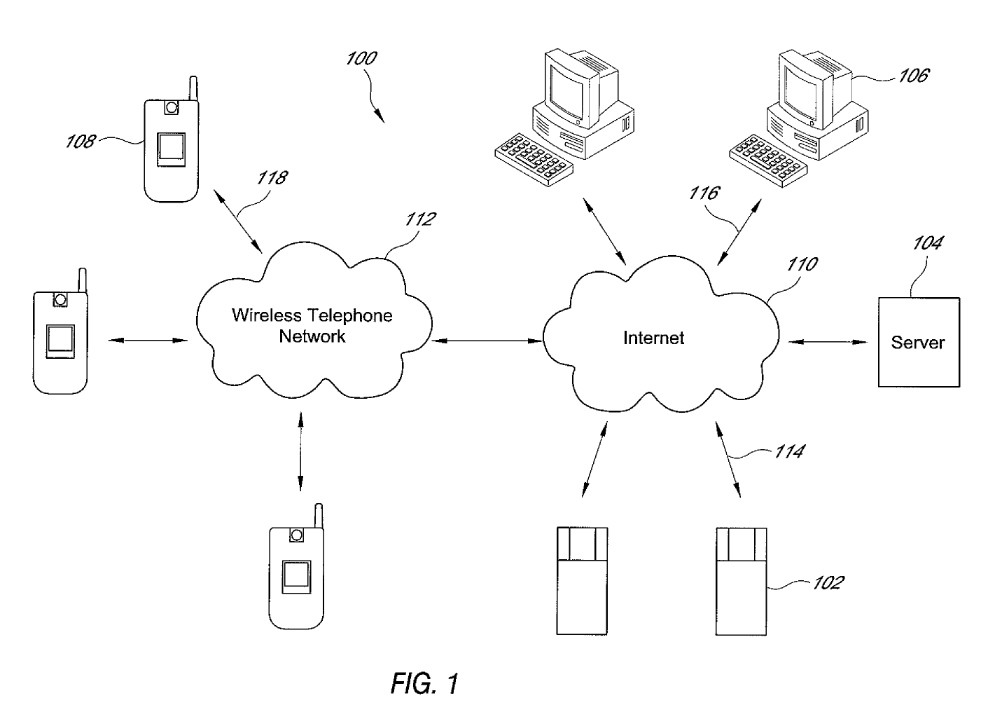

FIG. 1 is a diagram illustrating an example system 100 for capturing media on a wireless device 102 and for transmitting the captured media for display on a display device 106. The wireless device 102 is capable of capturing media and capable of transmitting media, as will be described in more detail below. The wireless device 102 can also transmit this media to a server 104, which may receive segments of the media as subsequent segments of the media are being captured and enable display of the captured media, as will be described in more detail below. The server 104 receives the captured media via the internet 110. The wireless device 102 may connect directly to the Internet 110, such as over a first communications link 114. In one embodiment, the wireless device 102 may also receive communications via the Internet 110 over the first communications link 114, such as from server 104.

The server 104 may also communicate with other devices connected to the Internet 110. For example, the display device 106 may connect to the Internet 110 over a second communications link 116, enabling the display device 106 to communicate with the server 104. Some devices, such as a wireless telephone 108, may be connected indirectly to the Internet 110. The wireless telephone 108 is connected to a wireless telephone network 112 over a third communications link 118, which is connected to the Internet 110 and may allow communications with the server 104.

The wireless device 102 may comprise at least one of a mobile handset, PDA (Personal Data Assistant), laptop, or any other electronic device capable of capturing media and transmitting the media to the server 104 via the Internet 110. For example, components of the wireless device 102 that will be described in more detail below may be incorporated into a personal organizer, entertainment device, headset, camera, or any other suitable device. In one embodiment, components of the wireless device 102 may be incorporated into the wireless telephone 108. Hence, descriptions of the wireless device 102 may also pertain to the wireless telephone 108, even if an embodiment of the wireless telephone 108 requires the wireless telephone network 112 to connect to the Internet 110.

When transmitting information to the server 104 via the Internet 110, the wireless device 102 may connect directly to the Internet 110 over the first communications link 114. The first communications link 114 may comprise one or more wireless links, including one or more Wi-Fi, Wi-Max, Bluetooth, or IEEE 802.11 links, or any other link that allows wireless connection to the Internet 110. The first communications link 114 is illustrated as a bidirectional link and may be fully symmetric. It may also comprise a plurality of bidirectional links. In an alternate embodiment, the first communications link 114 may comprise a unidirectional link or plurality of unidirectional links, or may comprise a plurality of links, at least one of which is bidirectional and at least one of which is unidirectional.

The wireless telephone 108 may comprise a mobile or cellular telephone, or any other device configured to communicate with the wireless telephone network 112, and may be configured to transmit information to the server 104 via the wireless telephone network 112. When transmitting information to the server 104 by transmitting information first to the wireless telephone network 112, the wireless telephone 108 may connect to the wireless telephone network 112 over the third communications link 118. The third communications link 118 may comprise one or more wireless links, including one or more GSM (Global System for Mobile communications), UMTS (Universal Mobile Telecommunications System), UMTS-TDD (UMTS-Time Division Duplexing), CDMA (Code Division Multiple Access), CDMA2000, WCDMA (Wideband CDMA), TDMA (Time Division Multiple Access), FDMA (Frequency Division Multiple Access), or 1xEV-DO (Evolution-Data Optimized) links, or any other link that allows connection to the wireless telephone network 112.

The display device 106 may comprise a computer, such as a laptop computer or desktop computer. Other embodiments of the display device 106 include a PDA, entertainment device, or any other electronic device capable of receiving media from the server 104 and displaying the media. Components of the display device 106 may be incorporated into the wireless device 102 and/or the wireless telephone 108. Thus, one or both of the wireless device 102 and the wireless telephone 108 may also be a display device 106.

When receiving information from the server 104, the display device 106 may connect directly to the Internet 110 over the second communications link 116. The second communications link 116 may comprise one or more wireless links, such as those described above in reference to first communications link 114; one or more wired links, including one or more telephone (e.g., POTS), cable, Ethernet, PLC (Power Line Communication), or fiber optic links, or any other link that allows a wired connection to the Internet 110; or a combination of such links. The second communications link 116 is illustrated as a bidirectional link, but may comprise a unidirectional link or a plurality of bidirectional and unidirectional links, as described above in reference to the first communications link 114. The display device 106 may also connect to the Internet 110 via the wireless telephone network 112 using one or more links (not shown) similar to those described in reference to the third communications link 118.

The Internet 110 is a series of interconnected computer networks in which data is transmitted by packet switching. The Internet 110 is publicly accessible and can be navigated using Uniform Resource Locators (URLs), Internet Protocol (IP) addresses, or numerous other means known in the art. A device connected to the Internet 110, such as the server 104, can be located using one of the above means. Thus, the server 104 can be accessed over the Internet 110 in a variety of ways. A device connected to the Internet 110 and configured to display received media, such as the display device 106, may display media transmitted by the server 104 via the Internet 110. The operation of the Internet 110 and means of accessing resources connected to the Internet 110 is well known in the art.

The wireless telephone network 112 is a wireless network that may be configured to communicate data and/or voice traffic. The wireless telephone network 112 may be comprised of one or more base stations, access points, base station controllers, access point controllers, drift radio network controllers, serving radio network controllers, or any other devices or combination of devices that allow communicating wireless telephone data and/or voice traffic. The wireless telephone network 112 may connect to the Internet 110 using a data service such as GPRS (General Packet Radio Service), EGPRS (Enhanced GPRS), EDGE (Extended Data rates for GSM Evolution), CSD (Circuit Switched Data), HSPA (High-Speed Packet Access), or any other methods, services, standards, or architectures that allow connection of a wireless telephone network to the Internet 110.

In the illustrated embodiments, one or more wireless devices 102, display devices 106, and/or wireless telephones 108 will be described. The number of devices described at any time does not limit the scope of a described embodiment. Embodiments described herein are useful when one wireless device 102 is in communication with the server 104. Embodiments herein described are equally useful when a plurality of wireless devices 102 are present in the system 100 and at least one of the wireless devices 102 is in communication with the server 104 The wireless device 102 may be in communication with the server 104 via the Internet 110, as described above, or by use of other means not herein described that will allow transmission of media to the server 104. In addition, any number of display devices 106 and/or wireless telephones 108 may be present in the system 100 and in communication with the server 104 using the means described above.

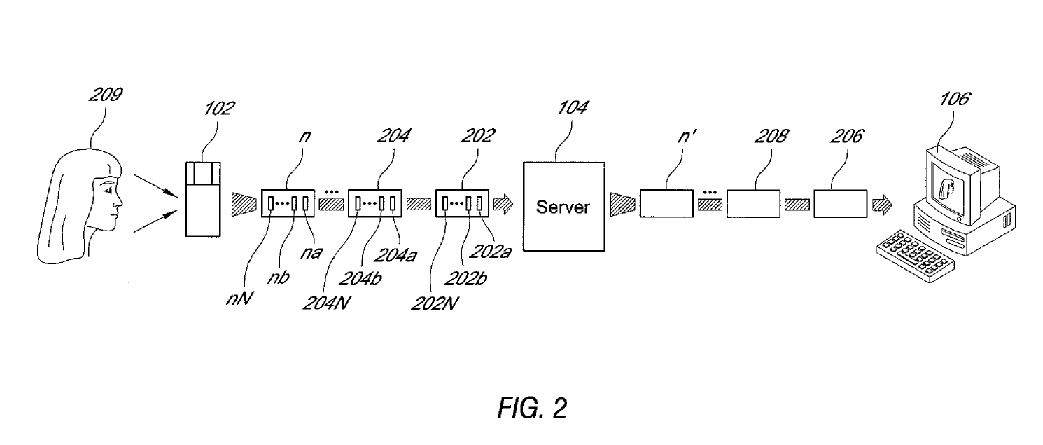

FIG. 2 is a diagram illustrating the capture of media on the wireless device 102 and the transmission of the captured media for display on the display device 106. FIG. 2 illustrates an embodiment of how portions of a scene or subject 209 can be captured on a wireless device 102 and transmitted for display on the display device 106 while subsequent portions of the scene 209 are still being captured by the wireless device 102.

The scene 209 is captured as media on the wireless device 102. The scene 209 may comprise an individual, an object, a series of actions, or any other visual content that a user of the wireless device 102 wishes to capture. The scene 209 may also comprise audible content that the user wishes to capture.

The wireless device 102 captures visual media of the scene 209 as frames of image information. The wireless device 102 may also capture audible media of the scene 209 as audio information. The captured audible media may comprise samples of audio information. At least a frame of image information, alone or in combination with audio information, captured by the wireless device 102 may be referred to as “video data.” A series of video data, and thus a series of frames (e.g. two or more frames) alone or in combination with audio information, may be accumulated as a “video segment.” The series of video data may be accumulated as a video segment of a certain length, which length corresponds to display time on a normal display device.

The wireless device 102 captures a first video segment 202 and sends the video segment 202 to the server 104. The video segment 202 comprises video data 202a through 202N. The amount of the video data 202a through 202N contained in the video segment 202 and/or the size of the video segment 202 depends on at least one capability of the wireless device 102, as will be described below.

The wireless device 102 may capture a subsequent video segment 204 or a portion of the video segment 204 while the wireless device 102 is transmitting the video segment 202 to the server 104. The video segment 204 comprises video data 204a through 204N. After the wireless device 102 finishes transmitting the video segment 202 and capturing the video segment 204, the wireless device 102 may transmit the video segment 204 to the server 104.

While the video segment 204 is being transmitted to the server 104, a subsequent video segment comprising video data, or a portion of such video segment, may be captured by the wireless device 102. Such capture and transmission of video segments can continue until a last video segment n comprising video data na through nN, or a portion of the video segment n, is captured while a previous video segment is being transmitted, and until the video segment n is transmitted to the server 104.

The video segment n at which the capture of media terminates is determined by an input from the user or by the wireless device 102 being unable to capture additional media, such as when there is loss of power. This termination point will not be determined by the physical capacity of the memory of the wireless device 102 if the wireless device 102 deletes video segments after they have been transmitted to the server 104.

After the video segment 202 is received by the server 104, the video segment 202 may be processed to optimize the video data 202a through 202N or to enable the video segment 202 to be transmitted for display on the display device 106, as will be described below. The video segment 202 may also be transmitted to a streaming server, which may be implemented internal to or external to the server 104, as will be described below.

From the server 104, the video segment 202 is transmitted to the display device 106 in one or more transmission segments 206, 208, through n′. The transmission segment 206 may comprise the video data 202a through 202N, or the transmission segment 206 may comprise more or less video data. The video data contained in the transmission segment 206 may be determined by the streaming server, by a transmission protocol such as TCP, or by a combination of these, among other factors.

The video segment 204 is received and processed by the server 104 such that it may be transmitted to the display device 106 immediately following the transmission of the video segment 202 to the display device 106. To facilitate this immediate transmission of the video segment 204, the transmission of the video segment 202 from the server 104 may be delayed to compensate for factors, such as network delay, affecting the reception of the video segment 204 and subsequent video segments. The video segment 204 is then transmitted in one or more of the transmission segments 206, 208, through n′.

Transmission of video segments to the display device 106 immediately following transmission of a previous video segment to the display device 106 continues until the video segment n is received and transmitted. The transmission segments 206, 208, through n′ are transmitted to the display device 106 such that the video data 202a through nN contained in the video segments 202 through n can be displayed in the order in which the video data 202a through nN were captured. Those of skill in the art will appreciate, however, that the video data 202a and the video segment 202 may be transmitted to the display device 106 before the wireless device has captured the video data nN or the video segment n.

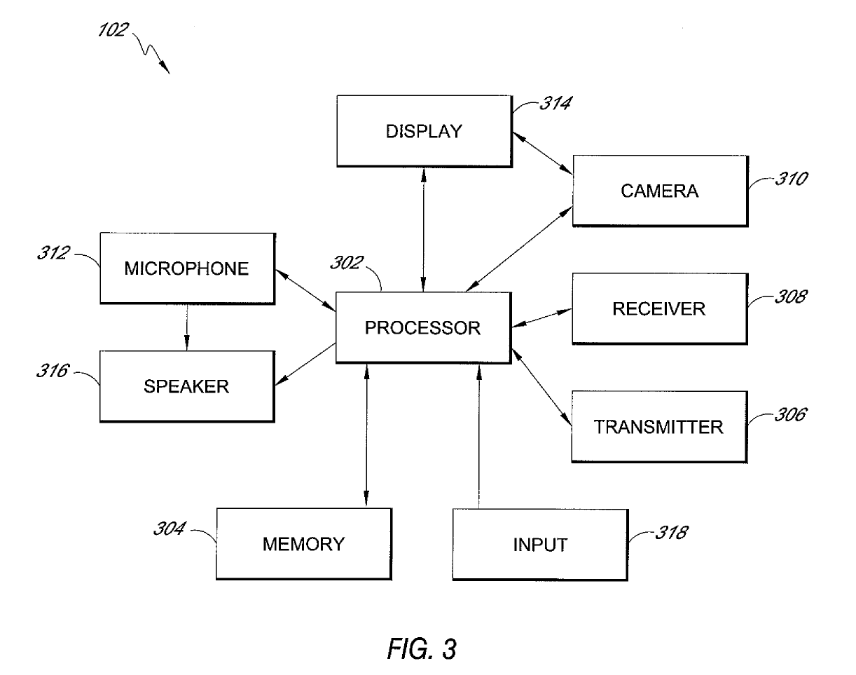

FIG. 3 is a block diagram illustrating an example of the wireless device 102 of the system 100, such as illustrated in FIG. 1. The wireless device 102 includes a processor 302 in communication with a memory 304 and a transmitter 306. The processor 302 may be a conventional processor, microprocessor, controller, microcontroller, state machine, or any other device or module capable of performing data operations. The memory 304 may be a hard disk, RAM memory, flash memory, removable disk, or any other medium or device capable of storing information. The memory 304 is coupled to the processor 302 such that the processor 302 can read information from, and write information to, the memory 304. In the alternative, the memory 304 may be integral to the processor 302. As was discussed with reference to FIG. 1, the transmitter 306 is configured to transmit information over the first communications link 114 and/or the third communications link 118. Optionally, the transmitter 306 may also have processing capabilities to reduce processing requirements of the processor 302.

The wireless device 102 may also include a receiver 308 configured to receive information over the first communications link 114 and/or the third communications link 118. In one embodiment, the transmitter 306 and the receiver 308 are contained in a single network interface, such as a transceiver. The wireless device 102 is not limited to containment of the transmitter 306 and the receiver 308 in a single network interface, however, and the transmitter 306 may be implemented independently of the receiver 308.

The wireless device 102 may also include a second transmitter, receiver, and/or network interface (not shown). Such second interface may be configured to provide an alternate means of transmitting and/or receiving information over a communications link which the transmitter 306 and/or the receiver 308 communicates over. In another embodiment, the transmitter 306 and/or the receiver 308 may communicate over a communications link, such as the first communications link 114, while the second interface communicates over another communications link, such as the third communications link 118.

The wireless device 102 also includes a camera 310 and a microphone 312. Camera 310 is configured to capture image information and may capture a series of image information. Microphone 312 is configured to capture audio information. Thus, the wireless device 102 is configured to capture “video data,” as described above. The wireless device 102 is further configured to accumulate the video data into a video segment. The video segments may be captured as individual images and/or samples of audio and later accumulated, or may be captured using a video and/or audio codec to accumulate the video data at the time of capture. Video data, video segments, other captured information, and/or the codec may be stored in the memory 304. Although the wireless device 102 has been described as including the camera 310 and the microphone 312, the wireless device 102 may instead or in addition include any other electronic device or module capable of capturing media. For example, the wireless device 102 may store portions of media received with the receiver 308 into the memory 304. The wireless device 102 may also, for example, include a module configured to receive media over a wired connection and store such media in the memory 304.

The wireless device 102 may also include a display 314 and a speaker 316 in communication with the processor 302. The display 314 may be used to display image information as it is being captured by the camera 310 or it may be used to display image information stored in the memory 304. Similarly, the speaker 316 maybe used to reproduce audio information as it is being captured by the microphone 312 or may be used to reproduce audio information stored in the memory 304. The display 314 may also be used to display image information and/or the speaker 312 may be used to reproduce audio information received by the receiver 308, such as over the first communications link 114 and/or the third communications link 118. The display 314 may be configured to display information and the speaker 316 may be configured to reproduce information from any other device or module capable of capturing media included in the wireless device 102.

The wireless device 102 also includes an input 318 in communication with the processor 302. The input 318 can be used to enter commands or instructions into the processor 318 and may be a keypad, touch screen, or any other input device that allows for entry of commands. For example, the input 318 can be used to command the camera 310 and/or the microphone 312 to begin or finish capturing image and/or audio information. The input 318 may also be used to command the memory 304 to save or delete captured image and or audio information. In addition, the input 318 may be used to command the wireless device 102 to begin or finish transmitting information using the transmitter 306 or to begin or finish receiving information using the receiver 308, such as over the first communications link 114 and/or the third communications link 118. Representations of commands entered with the input 318 may be displayed on the display 314 or reproduced as sounds using the speaker 316. The input 318 may also be used to enter a variety of different commands into the wireless device 102, the extent of which will vary based on the type and configuration of the wireless device 102. For example, the input 318 may be used to initiate or begin receiving a telephone call using the speaker 316 and the microphone 312. The input 318 may also be used to, for example, input text and command the transmitter 306 to send or the receiver 308 to receive messages using SMS (Short Message Service).

Described components of the wireless device 102 may be implemented in a variety of ways. For example, FIG. 3 represents components as interrelated functional blocks. Each block may be implemented as a separate electrical component or multiple blocks may be integrated into a single component. Alternatively, each block may comprise a collection of components or modules. In addition, the blocks may be implemented using appropriately configured hardware or by way of executing appropriately programmed software. The components may be modules included in other components that may or may not be shown in FIG. 3. Also, the components may be interconnected in configurations in addition to or in place of the connections shown in FIG. 3. Those skilled in the art will appreciate the different ways in which described components of the wireless device 102 may be implemented.

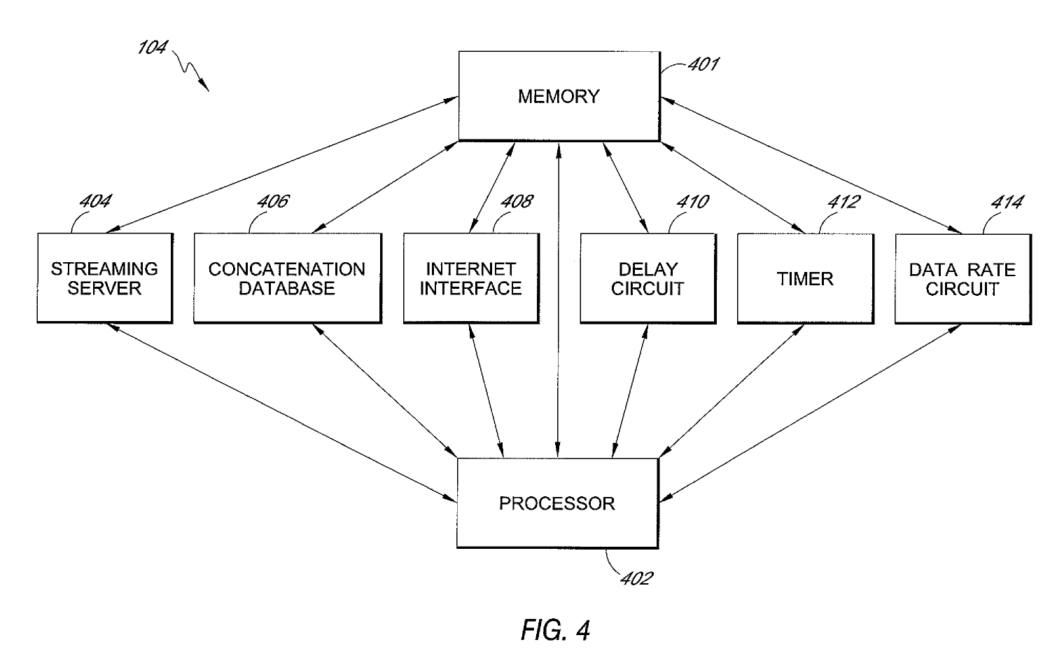

FIG. 4 is a block diagram illustrating an example of the server 104. The server 104 includes a memory 401 in communication with a processor 402. Both the memory 401 and the processor 402 are in communication with a streaming server 404, a concatenation database 406, an internet interface 408, a timer 410, a delay circuit 412, and a data rate circuit 414. The memory 401 may be any of the mediums or devices described in reference to the memory 304 of the wireless device 102. The processor 402 may be any of the processing devices or modules described in reference to the processor 302 of the wireless device 102. The memory 401 and the processor 402 similarly may be coupled to each other and implemented independently or integrally as are the memory 304 and the processor 302.

The internet interface 408 is configured to receive and transmit data over the Internet 110, illustrated in FIG. 1. More specifically, the internet interface 408 is configured to receive video segments and to send video segments and/or individual video data over the Internet 110. Received video segments may be stored in the memory 401.

The streaming server 404 is configured to receive video segments from the memory 401 or the processor 402, and to transmit these video segments for display, such as on a display of the display device 106 or on the display 314 of the wireless device 102, as shown in FIG. 2. The video segments may be transmitted using the internet interface 408 or using another device or module, such as another internet interface contained within or coupled to the streaming server 404. The video segments are transmitted for display in substantially the same order as received by the streaming server 404. By transmitting the video segments for display in this way, streaming server 404 is enabled to “stream” the video segments to another device.

The video segments transmitted for display by streaming server 404 may be viewed by a device configured to receive and display such video segments. Either or both wireless device 102 or display device 106 may be configured to receive and display such video segments, as can other devices not herein described. Methods and devices for receiving and displaying “streamed” media are known to those skilled in the art.

One embodiment of the streaming server 404 includes commercially available software, such as the Darwin streaming server. Another embodiment may include a streaming server integrated into the server 104 or designed to “stream” media in a format recognized by a predetermined device or software. Thus, it can be appreciated by those skilled in the art that the server 104 and the streaming server 404 can be configured to operate with existing devices, which may include the wireless device 102 and the display device 106. Therefore, a user of the wireless device 102 and/or the display device 106 may be able to view displayed video without specialized hardware and without being required to purchase a separate device. The streaming server 404 may, however, be configured to transmit media in a format that is unique.

The concatenation database 406 is configured to receive multiple video segments from the memory 401 or the processor 402, and to create a single video file from the multiple video segments. Display of the single video file, such as on the display device 106, may emulate display of the “streamed” video segments transmitted by the streaming server 404. An example of a method for producing a complete video file at concatenation database 406 is described in more detail below.

The delay circuit 410 is configured to determine a delay according to a predetermined algorithm or an algorithm that may be set in the delay circuit 410. Such an algorithm to determine a delay during which to postpone transmission of a video segment from the memory 401 or the processor 402 to the streaming server 404 will be described below.

The timer 412 is configured to verify the passage of time. For example, the timer 412 can used to insure that a delay determined in the delay circuit 410 has elapsed. Thus, the server 104 can postpone the streaming server 404 from receiving a video segment from the memory 401 or the processor 402 for a given delay, as will be described in more detail below.

The data rate circuit 414 is configured to determine a rate at which data is being or has been received by the internet interface 408 over the Internet 110. The data rate circuit 414 may determine the rate based on the reception of a video segment or video data, or the data rate circuit 414 may determine the rate based on other received data, such as test data transmitted with the purpose of determining the speed at which data can be received.

Although the server 104 is illustrated as containing the components 401-414 described above, the components 401-414 of the server 104 may also be implemented external to the server 104 and coupled to the server 104. For example, the streaming server 404 may be included as a component in the server 104 or implemented separately or externally to the server 104. In addition, the components 401-414 may each be a single device or module, or each may be implemented as a plurality of devices or modules or combined into a fewer number of devices or modules. For example the functionalities of the concatenation database 406 may be split among different devices or modules.

Although the server 104 has been described as a server connected to the Internet 110, as shown in FIG. 1, the server 104 is not limited to this configuration or to being a physical “server” as is traditionally understood in the art. The server 104 may instead by any number of devices or modules configured to receive information from the wireless device 102 over the Internet 110 or by way of other methods. For example, one embodiment may include a server 104 implemented in the wireless telephone network 112. Another embodiment may include a server 104 implemented in a device such as the display device 106.

The components 401-414 may be implemented using appropriately configured hardware or by way of executing appropriately programmed software. The components may be modules included in other components that may or may not be shown in FIG. 4. Also, the components 401-414 maybe interconnected in configurations in addition to or in place of the connections shown in FIG. 4. Those skilled in the art will appreciate the different ways in which described components of the server 104 may be implemented.

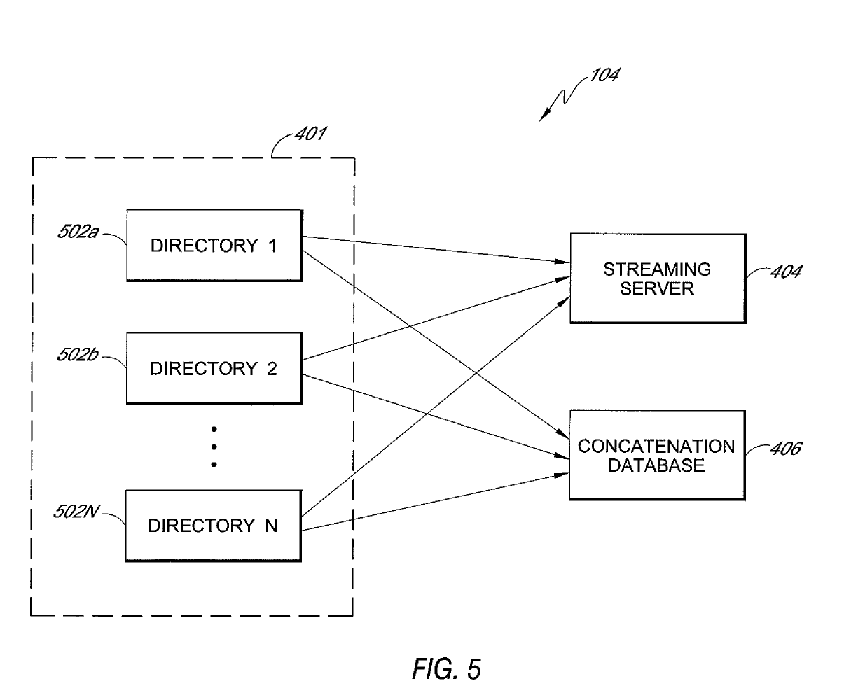

FIG. 5 is a block diagram further illustrating an example of the server 104, such as illustrated in FIG. 1. FIG. 5 illustrates in more detail an embodiment of how the memory 401 of the server 104 may communicate with the streaming server 404 and the concatenation database 406.

As described in reference to FIG. 4, the server 104 includes the memory 401, the streaming server 404, and the concatenation database 406. The memory 401 includes directories 502a-502N. Each directory 502a-502N is in communication with both the streaming server 404 and the concatenation database 406.

The directories 502a-502N are configured to store video segments and are dynamic. At any given time, the directories 502a-502N may contain no video segments or one or more video segments. The video segments may be created, deleted, received, or transmitted as needed, as explained in more detail below. Also, at any given time, there may be no directories, a single directory 502a, or a plurality of directories 502a-502N. Directories may be created as explained in more detail below. Directories may also be deleted when empty or when otherwise no longer needed.

Both the streaming server 404 and the concatenation database 406 are configured to receive video segments from the directories 502a-502N. The video segments may be received or retrieved directly from the memory 401, or reception may be facilitated by use of the processor 402 (not illustrated in FIG. 5). In addition, multiple complete streaming servers 404 or concatenation databases 406 may exist and may be in communication with one or more directories 502a-502N. For example, a single complete streaming server 404 and/or a single complete concatenation database 406 may be in communication with each directory 502a-502N.

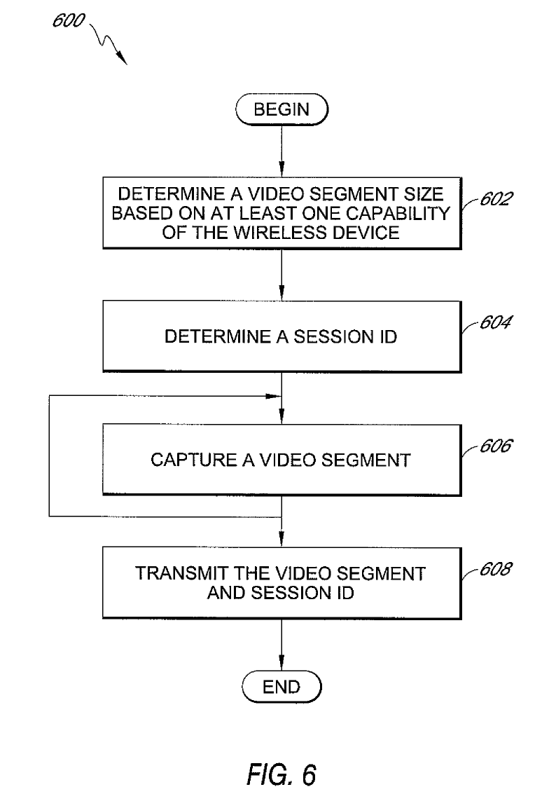

FIG. 6 is a flowchart illustrating an example of a method 600 for transmitting video segments from the wireless device 102, such as illustrated in FIG. 3. Description of the method 600 will be made according to FIG. 6, with references to components of the wireless device 102 illustrated in FIG. 3.

At block 602, the wireless device 102 determines a size of a video segment to be captured and transmitted. This size determination is based on at least one capability of the wireless device 102.

The at least one capability may include a speed of the processor 302, a resolution of the camera 310, a bitrate at which the microphone 312 is capable of capturing audio, or other such capabilities. The capabilities may be determined or accessed using a variety of methods. For example, the memory 304 may be programmed with the capabilities of the wireless device 102 at the time of manufacture. The processor 302 may also be able to determine the capabilities of the wireless device 102 based on information acquired by the various components of the wireless device 102. The determined capabilities may then be stored in the memory 304 for future reference.

The video segment is comprised of a series of video data. As described above in reference to FIG. 2, the size of the video segment is thus larger than a single frame of image information or video data, a single sample of audio information, or a combination of such information and/or data. Such a video segment size can provide many advantages over single frames or samples of information and/or data. For example, single frames or samples may be lost or “dropped” when being transmitted from the wireless device 102 to another device due to network error and/or congestion. If the reception of such a frame or sample is time sensitive, such as when using received frames to display live video, the loss or delay of such a frame or sample may be detrimental. In the case of receiving frames for display of live video, such a loss or delay may interrupt the video and cause a viewer to miss crucial information, or may even break the connection between the wireless device 102 and the other device.

In contrast to the use of a single frame or sample, use of a video segment size that is larger than a single frame or sample of information and/or data allows the wireless device 102 to transmit captured video segments in succession without risk of data loss. If a frame; sample; transmission packet created from the frame or sample; or several frames, samples, or packets are lost or delayed during transmission, the lost data can be retransmitted before reception of the entire segment is completed by another device. In the case where a video segment takes less time to be transmitted from the wireless device 102 than to be captured by the wireless device 102, portions of the video segment can be retransmitted multiple times if necessary before the next segment is ready to transmit. Thus, any time sensitive data will be received by the other device before subsequent data is transmitted by the wireless device 102, even if transmitted over a network with a low data rate or high data loss rate. These advantages are especially beneficial in wireless networks, some of which experience significant delays in data transmission and associated loss of data.

An example of the above described benefits of a video segment size larger than a single frame or sample of information and/or data can be illustrated with respect to transmitting and displaying nearly live video. When transmitting video for live display, video segments can be transmitted one immediately after another and immediately displayed upon reception. To test how a video segment larger than a single frame or sample would affect this process, a video segment having a length of twenty seconds was transmitted from a Sony Ericsson Z750i® wireless telephone over a GSM network provided by AT&T, Inc. The video segment required approximately ten seconds to transmit to a server connected to the Internet. Thus, an additional ten seconds in which to retransmit any lost or delayed data existed before the Z750i® wireless telephone could have captured another twenty second video segment to transmit. Similarly, an additional ten seconds in which to retransmit any lost or delayed data existed before a previously received twenty second video segment would have finished displaying. Therefore, transmitted video was not available for display for a short period of time after capture of the video began—in this example, approximately thirty seconds—but display of the video could be accomplished, possibly while portions of the video were still being captured, without loss or interruption.

Returning to block 602, the wireless device 102 determines the video segment size such that data lost while transmitting the video segment can be retransmitted before a further video segment of similar size can be captured. A speed of the processor 302, a data rate at which the transmitter 306 can transmit, a resolution of the camera 310, a bitrate at which the microphone 312 captures audio, and/or other capabilities of the wireless device 102 may be used to determine the video segment size. In one embodiment, the wireless device 102 calculates the video segment size based on at least one capability of the wireless device 102. In another embodiment, the video segment size may be stored in the memory 304 or another storage device located on the wireless device 102. The stored video segment size may have been determined by the wireless device 102 previously or may have been determined, based on at least one capability of the wireless device 102, and stored in the memory 304 before the wireless device 102 is sold to a consumer. In such an embodiment, the wireless device 102 can determine the video segment size by reading the video segment size from the memory 304.

The video segment size may be specified in any number of ways. For example, the video segment size may be determined to be a length of twenty seconds of video data. Alternately, the video segment size may be determined to be 300 kilobytes or 500 frames of information and/or data. Additionally, the video segment size may be a determined size, an approximate size, a preferred or optimal size, a preferred size or optimal size and an alternate size and/or sizes, and/or a range or ranges of sizes. The way in which video segment size is specified does not affect the embodiments herein described.

In one embodiment, determining the video segment size at block 602 is accomplished by reference to a table that associates models of the wireless device 102 with a video segment size. The video segment sizes will have been determined according to the capabilities of the wireless device 102 identified in the table, as has been described above. To determine an appropriate video segment size, the wireless device 102 can use its model type to refer to the table for the appropriate video segment size. The table may be stored on the wireless device 102, such as in the memory 304, or may be stored on another device, such as on the server 104. To retrieve the appropriate video segment size from another device, the wireless device 102 may transmit its model or type, such as over the first communications link 114 and/or the third communications link 118 using the transmitter 306, and may receive back an appropriate video segment size, such as over the first communications link 114 and/or the third communications link 118 using the receiver 308. Alternatively, the wireless device 102 may receive a parameter to be used in calculating the video segment size from another device. The wireless device 102 may retrieve a video segment size or parameter from the other device each time a capture is initiated or may determine the video segment size for a certain capture and store it for future use.

An example of a table associating a model or capability of the wireless device 102 with a video segment size is shown below for an embodiment where the wireless device 102 is a mobile telephone. Although the table illustrates both models of mobile telephones and the processor speed of such telephones, either the model or the processor speed alone can be used to determine the segment size. In addition, the video segment size is specified as both a size in kilobytes and as a length of video to capture. Either the size in kilobytes or length alone can be used to specify the video segment size.

| | Processor | | |
|---|---|---|---|
| | Speed | Video Segment Size | Video Segment |
| Model | (MHz) | (length in seconds) | Size (kB) |
| Motorola Razr | 202 | 20 | 180 |
| Motorola Razr2 | 309 | 20 | 320 |
| Sony Ericsson K850i | 89 | 15 | 190 |
| Nokia N76 | 264 | 20 | 400 |

One embodiment of an algorithm that may be used to determine the video segment size comprises the following. If a speed of the processor 402 is greater than 200 MHz, then the video segment size is 20 seconds. Otherwise, the video segment size is 15 seconds.

At block 604, the wireless device 102 determines a session ID of one or more video segments to be captured and transmitted. A unique session ID is determined for each capture performed by the wireless device 102. As that captures can vary in size and length, a single video segment or many different video segments may have the same session ID.

The session ID can be any identifier that will uniquely identify one or more video segments. For example, a session ID may comprise a manufacturer's device ID of the wireless device 102 in combination with a counter that gets advanced each time a new capture is performed. As another example, if the wireless device 102 is a mobile telephone, the session ID may comprise a date and time when a capture was started appended to a phone number of the wireless device 102.

Although the session ID is illustrated in FIG. 6 as being determined after the video segment size is determined, the session ID may be determined at any time before transmission of the first video segment in a capture. For example, the session ID may be determined before the video segment size is determined or simultaneously with the capture of a first video segment in a capture. The session ID may be stored in the memory 304 so that it will be available if the capture is lengthy.

At block 606, the wireless device 102 captures a video segment. Video data is captured using the camera 310 alone or along with the microphone 312. As the video data is captured, it is stored in the memory 304 until a video segment of the size determined at block 602 has been captured.

The wireless device 102 may capture the video segments using a codec or may capture individual images and samples of audio. For example, many mobile telephones capture video using the camera 310 alone or in combination with the microphone 312, and use a codec to encode the video into a 3GP format. Alternatively, the wireless device 102 may capture still images using the camera 310. Fifteen images per second of video are needed for the motion in the video to appear fluid, but more or fewer images may be captured according to the wireless device capabilities. The size of the images can be adjusted to increase the speed at which the images can be captured. Simultaneously, an audio track may be captured by the microphone 312. The audio track can be synchronized with the images using an internal clock of the wireless device 102, and a series of images and a corresponding segment of audio can be inserted into a single file, which herein is still referred to as a video segment. Such capture method may be particularly useful in phones lacking a codec necessary to capture video, such as the iPhone™, from Apple, Inc.

At block 608, the wireless device 102 transmits the video segment captured at block 606 and the session ID determined at block 604, such as over the first communications link 114 or over the third communications link 118 using the transmitter 306. The processor 302 reads the video segment from the memory 304 and provides the video segment and session ID to the transmitter 306 to transmit. The processor 302 may compress the video segment before providing it to the transmitter 306 to transmit. The transmitter 306 transmits the video segment and session ID to another device, such as to the server 104. In an embodiment where the wireless device 102 is a mobile telephone, such transmission may be accomplished using an SMS transmission or an Internet data call may be initiated by opening a port to transmit to an Internet address, for example. After transmission is complete, the video segment may be erased from the memory 304 or may be retained for later access. The video segment may be retained as a separate video segment or may be retained as a portion of a complete capture of video data.

If the wireless device 102 is still capturing video data after completion of the capture of the video segment at block 606, then the transmission at block 608 is accomplished simultaneously with the capture of another video segment at block 606. Thus, the wireless device 102 transmits a video segment and session ID at the same time as it is capturing a subsequent video segment. When capture of the subsequent video segment at block 606 is completed, the wireless device 102 transmits the subsequent video segment and session ID at block 608. This process continues as long as the wireless device 102 continues to capture video data.

Such transmission of a video segment and subsequent video segments is automatic; it requires no additional input from the user. If a video segment is erased from the memory 304 after being transmitted at block 608, then the length of a capture will not be limited by the size of the memory 304. In this way, lengthy captures of several minutes or even several hours can be accomplished. In such circumstances, a user of the wireless device 102 will not have to manually transmit a capture to another device at a later time in order to free storage space, and will not be limited in how much data be can capture.

Although the above description of FIG. 6 referred to operation of the wireless device 102, the described example method may be implemented in any number of devices. For example, a display device 106 configured to capture one or more video segments and transmit the video segments as described above may be used to execute the example method.

Those of skill in the art will appreciate that the example method described with reference to FIG. 6 can be implemented in a number of ways. For example, the method can be implemented using specific hardware in the wireless device 102, using software to configure the wireless device 102, or using a combination of these implementations. Depending on the particular implementation chosen, it may be possible to execute the example method without requiring specialized hardware.

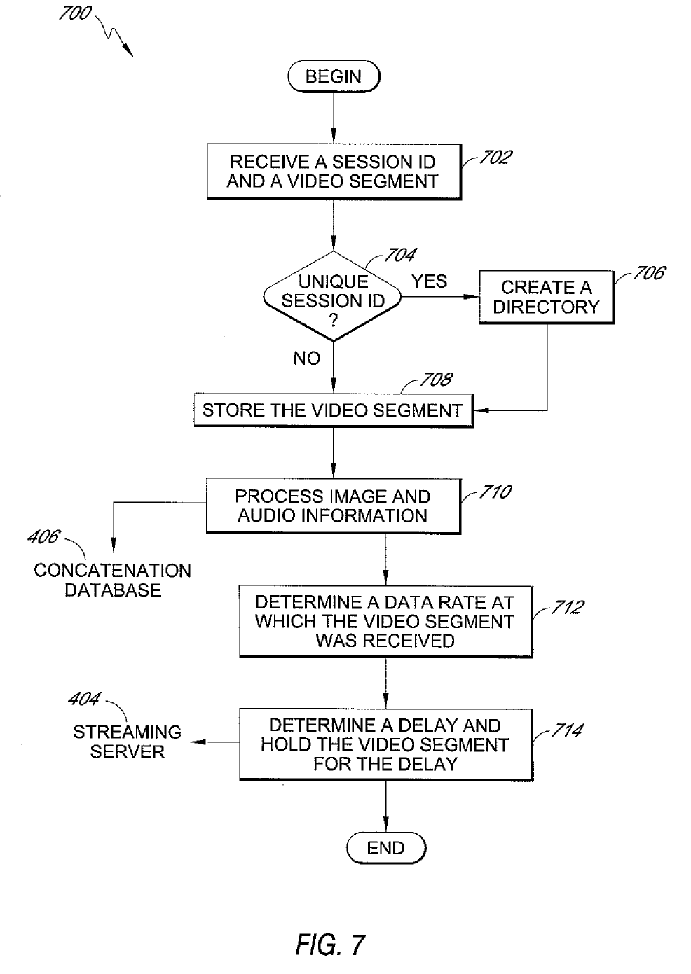

FIG. 7 is a flowchart illustrating an example of a method 700 for processing video segments at the server 104, such as illustrated in FIGS. 4 and 5. Description of the method 700 will be made according to FIG. 7, with references to components of the server 104 illustrated in FIGS. 4 and 5.

At block 702, the server 104 receives a video segment and a session ID of the video segment. This segment may be received over the Internet 110, illustrated in FIG. 1, by the internet interface 408 or by other means, as has been previously described.

At block 704, the server 104 determines whether the session ID is unique. If the session ID is unique, then the server 104 continues to block 706. If the session is not unique (i.e. server 104 has received the session ID before), then the server 104 continues to block 708 and does not perform block 706.

At block 706, a directory 502a is created. The created directory 502a may be the only directory, or may be one of many directories 502a-502N. The directory provides a common storage area for video segments with corresponding session IDs.

At block 708, the video segment is stored in the directory 502a associated with the video segment's session ID. If a directory was created at block 706, then the video segment is stored in that directory. If a directory was not created at block 706, then the session ID of the video segment is not unique and a directory must exist where another video segment with a corresponding session ID is stored or has been stored.

Alternatively, the received video segment may be stored in the memory 401 of the server 104 without storing the video segment into directory 502a or creating directory 502a. Such method of storage is encompassed by the example method herein described as long as the video segment can still be identified as being associated with other video segments with corresponding session IDs. For example, this alternate method of storage would operate well when the session ID is stored with the video segment or when all received video segments have the same session ID.

At block 710, the server 104 may process the image and/or audio information in the video segment. To perform this processing, the server 104 may first split the image information from the audio information in the video segment if both are present. The image information may be converted from a format in which the wireless device 102 of FIG. 2 captures to a standard format. Such standard format may be a format which may be utilized by a display device to display the image information, or the standard format may be a format which the streaming server 404 utilizes. For example, mobile telephones often capture video in 3GP format, and the server 104 may convert the video from 3GP format to MPG format. The MPG format can be displayed by many display devices, as is known in the art. The image information may also be optimized, such as by improving the contrast or coloration of the image information. If the video segment is a file containing a series of individual images and a corresponding segment of audio, such as may be received if the wireless device 102 lacks a codec necessary to capture video, then the individual images may be removed from the video segment and processed into a video format, such as MPG.

The audio information may be similarly processed. The audio information may also be converted into a standard format, such as MP4, that can be reproduced by display devices. The audio information may additionally be optimized, such as by increasing the volume.

The audio and the image information may or may not be reassembled or spliced together into a single video segment again. Depending on the type of streaming server 404 implemented in the server 104, the video segment may be transmitted to the streaming server 404 as separate image and audio information if both are present in the original video segment. Although a video segment will be subsequently described, such description will be understood to encompass a reassembled video segment, a video segment composed of separate image and/or audio information, or a video segment that was never separated into image information and audio information after being received by the server 104.

Other processing that might be performed by the server 104 at block 710 includes hinting, compression, and/or decompression of the video segment, for example. The video segment might have data appended to it, known as “hinting,” that will allow the streaming server 404 to properly transmit the video segment for display. The video segment may also be decompressed if it was received in a compressed state by the server 104 or it may be compressed if received in an uncompressed state, depending on the implementation of the streaming server 404.

At block 712, the server 104 determines a data rate at which the video segment was received, such as using the data rate circuit 414. The data rate can be determined by comparing the amount of data in the video segment with the amount of time it took to receive the segment or using a number of other methods known to those skilled in the art. The data rate can be determined for each video segment received, for only video segments with unique session IDs, or for periodic video segments with corresponding IDs. The data rate may also be determined for each video segment with a corresponding ID until the video segments are transmitted for display.

At block 714, the server 104 determines a delay, such as using the delay circuit 410. The delay is based on the data rate determined at block 712 and signifies a time during which the video segment is held. The server 104 waits for that delay before transmitting the video segment for display. The video segment may not be transmitted to the streaming server 404 for display until after a time approximately equivalent to the delay, or in the alternative, the video segment may be transmitted to the streaming server 404 and the streaming server 404 instructed to wait for a time approximately equivalent to the delay before transmitting the video segment for display. The server 104 may ensure that the proper delay is observed by using the timer 412.

The delay may be specified in any number of ways. For example, the delay may be determined to be the reception of four video segments. Alternatively, the delay may be determined to be forty-five seconds or 600 kilobytes of data received. Additionally, the delay may be a determined delay, an approximate delay, a preferred or optimal delay, an alternate delay and/or delays, a range or ranges of delays, and/or a value from which to calculate any of these. The way in which the delay is specified does not affect the embodiments herein described.

The delay is determined such that once a first video segment is transmitted for display, all other video segments with corresponding session IDs can be transmitted thereafter without additional delay in substantially the same order in which they were received. Thus, the data rate at which one or more video segments were received is used to determine the delay to account for how long it will take to receive any video segments that have yet to be received by the server 104, transmitted by the wireless device 102, or even captured by the wireless device 102. According to this determination, a display device receiving the video segments for display can display the video segments without interruption and a user of the display device will perceive the video segments as a continuous video, even though no continuous video has existed. In fact, the user may perceive such a continuous video even though the server 104 has not received all video segments with a corresponding session ID and even though the wireless device 102 has not captured all video segments with a session ID.

In one embodiment, the server may directly calculate the delay based on the data rate at which a video segment was received. In another embodiment, the delay may be determined by referencing a table associating, for example, the amount of data in a video segment and the data rate at which the video segment was received with an appropriate delay. In yet another embodiment, the delay may be determined by reference to a table associating, for example, a model of the wireless device 102 from which the video segment was received and the data rate at which the video segment was received with an appropriate delay. For this embodiment, the server 104 must be apprised of the model of the wireless device 102, such as by receiving the model with the video segment or by storing the model if the wireless device 102 uses its model to consult a video segment size table stored in the server 104. Such tables may be stored on the server 104 or on another device. If stored on another device, then the server 104 may transmit the amount of data in the video segment and the data rate at which the video segment was received, and may then receive back an appropriate delay.

An example of a table associating an amount of data in a video segment and the data rate at which the video segment was received with an appropriate delay is shown below.

| Amount of Data | Data Rate | Delay |
|---|---|---|
| (kB) | (kbps) | (number of video segments) |
| 230 | 90 | 5 |
| 230 | 160 | 3 |
| 250 | 180 | 5 |
| 250 | 120 | Delay until all video |
| | | segments in the capture |
| | | have been received |

An embodiment of an algorithm that may be used by the delay circuit 414 to determine a delay comprises the following. If the video segment size is less tan 240 kB and the data rate is more than 80 kpbs, then the delay is five video segments and the server 104 should start transmitting the video segments for display after the fifth video segment has been received by the server 104. If the video segment size is less than 240 kB and the data rate is more than 150 kpbs, then start transmitting the video segments for display after the third video segment has been received by the server 104. If the video segment size is more than 240 kB and the data rate is more than 150 kpbs, then start transmitting the video segments for display after the fifth video segment has been received by the server 104. For all other situations, delay until all of the video segments in the capture have been received by the server 104.

Once one or more video segments have been transmitted to the streaming server 404 and the streaming server 404 has started transmitting video segments for display, it will continue to transmit video segments until no more video segments with corresponding session IDs exist at the server 104. The server 104, however, will continue to receive video segments during this time. Thus, the streaming server 404 may be transmitting video segments while the server 104 is receiving video segments with corresponding session IDs and transmitting them to the streaming server 404. In this way, video segments can be displayed before subsequent video segments are captured.

When the streaming server 404 includes commercially available software, such as the Darwin streaming server, the server 104 may have to trick the streaming server 404 into operating as if all video segments with corresponding session IDs exist and are stored on the server 104. This can be accomplished by indicating to the streaming server 404 that an extremely large number of video segments exist (e.g. more than could possibly exist), transmitting the video segments to the streaming server 404 as though the large number of video segments do exist (even if subsequent video segments are still being received), and then terminating the transmission of video segments for display being conducted by the streaming server 404 when there are no more video segments with corresponding session IDs. When there are no more video segments with corresponding IDs, the directory 502a in which the video was stored may deleted.

The server 104 may also transmit the video segment received at block 702 to the concatenation database 406 to create a video file from video segments with corresponding session IDs. This transmission may happen before the delay is determined at block 712 and/or before the video segment is transmitted to the streaming server 404, simultaneously with the video segment being transmitted to the streaming server 404, or after the video segment has been transmitted to the streaming server 404. An example of a method for using the concatenation database 406 is described in more detail below.

As discussed above, the server 104 is not limited to the configurations illustrated in FIGS. 4 and 5 or to being a device separate from a wireless device 102 or a display device 106. In addition, the example method 700 described with respect to FIG. 7 is not limited to the blocks or configuration of blocks described herein. Embodiments may contain more or less blocks or blocks in a different order than illustrated in FIG. 7.

Those of skill in the art will appreciate that the example method 600 described with respect to FIG. 6 and/or the example method 700 described with respect to FIG. 7 can be used to transmit video for display such that segments of the video are displayed while other segments of the video are still being captured. Thus, one or both of the example methods can be used to display video that is nearly live. In addition, one of skill in the art will appreciate that one or both of the example methods may be used to accomplish nearly live display of video independent of network speed or loss. Therefore, nearly live display of video can be realized even when transmitting data over wireless networks, some of which experience significant delays in data transmission and loss of data.

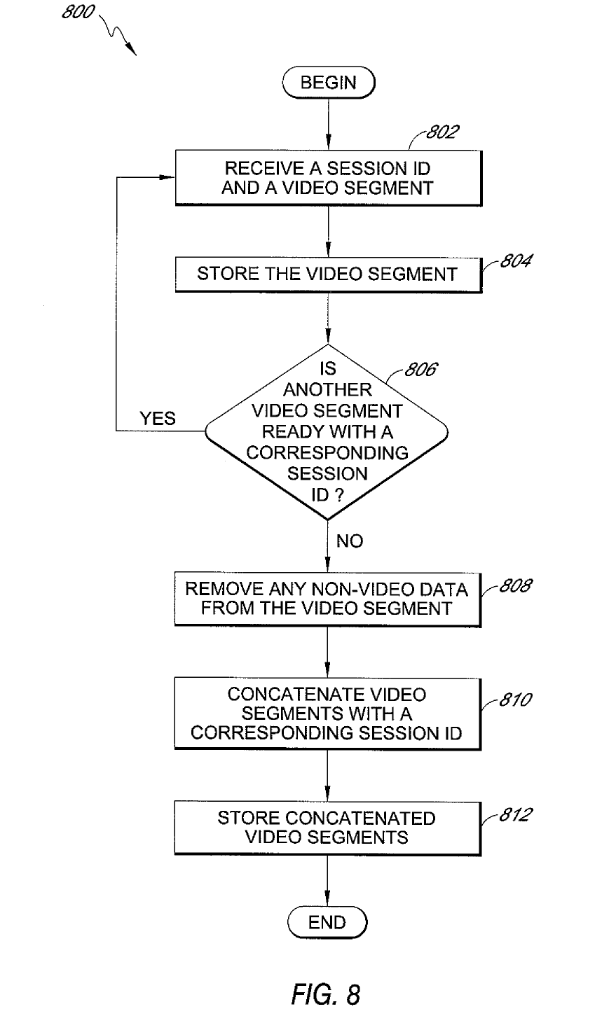

FIG. 8 is a flowchart illustrating an example of a method 800 for producing a complete video file at the concatenation database 406, such as may be contained in the server 104 as illustrated in FIG. 4. Various embodiments of the concatenation database 406 were described above with respect to FIGS. 4 and 5.

At block 802, the concatenation database 406 receives a video segment and the session ID of the video segment. The concatenation database 406 may also receive a time at which the video segment was received by the server 104, or was transmitted to the streaming server 404 or the concatenation database 406. Alternatively, the concatenation database 406 may track or record an order in which video segments were received by the concatenation database 406.

At block 804, the concatenation database 406 stores the video segment. The video segment may be stored in a directory created for the session ID of that video segment, similar to the directories 502a-502N of the server 104, illustrated in FIG. 5. The video segment may also be stored such that the time at which it was received can be identified or such that its order of reception can be identified. Methods of storing the video segment in the concatenation database 406 may vary and may be similar to those methods described in reference to storing a video segment in the server 104 at block 708 of FIG. 7.

At block 806, the concatenation database 406 waits for a predetermined amount of time before progressing to block 808. If another video segment with a corresponding session ID is ready for reception within that predetermined amount of time, then operation returns to block 802 so that the concatenation database 406 may receive the video segment and session ID and then store the video segment at block 804. If another video segment with a corresponding session ID is not ready for reception within the predetermined amount of time, then the concatenation database 406 proceeds to block 808.

The predetermined amount of time may have been determined by adding a time value to the time that it takes to transmit a video segment for display or by adding a time value to the time that it takes to display a video segment. Alternatively, if the video segment size is specified as a time value, the predetermined amount of time may have been determined as a multiple of the video segment size. Those of skill in the art will recognize other ways in which the predetermined amount of time may have been determined.

At block 808, the concatenation database 406 removes any data that is not video data from the video segment. This data may include headers that have been attached to facilitate transmission of the video segment, hinting data that was added, or any other data that is not video data that may have been appended to the video segment.

At block 810, the concatenation database 406 concatenates the video segment with any other video segments with corresponding session IDs that have been received by the concatenation database 406. At this time, the video segment has had all data that is not video data removed, as have the other video segments with corresponding session IDs. The concatenation joins, or links, the separate video segments into a single, possibly much larger video segment comprised of the video data of the separate segments. The separate video segments are joined in the order in which they were received or in an order according to any time information that may have been received by the concatenation database 406 with the video segments.

In one embodiment, the concatenation joins separate video segments with corresponding session IDs into a single concatenated video segment such that the single concatenated video segment contains all of the video data contained in the separate video segments. In another embodiment, the concatenation may omit duplicative video data when joining the separate video segments with corresponding session IDs into a single concatenated video segment. In this way, a concatenated video segment is created that contains all of the relevant video data of the separate video segments, but which may require less memory space to store than a concatenated video segment containing all of the video data contained in the separate video segments.

At block 812, the concatenation database 406 stores the concatenated video segment. This block includes storing only one video segment, as that video segment contains at least the relevant video data of all of the video segments with a corresponding session ID. At block 812, the concatenation database 406 may also append and/or store additional data that pertains to the concatenated video segment as a whole. This data may be similar to or distinct from data that was removed at block 808, and may allow display of the concatenated video segment or transmitting the concatenated video segment for display. For example, new header data pertaining to the whole concatenated video segment may be added or hinting data pertaining to the whole concatenated video segment may be added. In this way, a single video segment is created that may be displayed or transmitted for display.

Those skilled in the art will appreciate that the example method 800 described above with reference to FIG. 8 can be used to generate a single video segment that when displayed will appear substantially similar to the display of separate video segments as illustrated in the example method described with reference to FIG. 7. Thus, the example methods described with reference to FIGS. 7 and 8 can both be used to transmit for display video data captured on the wireless device 102, although the example method 700 describes an embodiment in which nearly live video data that may be part of an incomplete video may be transmitted for display, while the example method 800 describes an embodiment in which a single file that may be transmitted for display may be created from existing video data.

Those skilled in the art will recognize that described blocks, components, devices, modules, elements, methods, algorithms, components, or aspects may be implemented using a variety of configurations or steps. No single example described above constitutes a limiting configuration or number of steps. For example, configurations exist in which the described examples may be implemented as electronic hardware, computer software, or a combination of both. Illustrative examples have been described above in general terms of functionality. More or less components or steps may be implemented without deviating from the scope of this disclosure. Those skilled in the art will realize varying ways for implementing the described functionality, but such implementation should not be interpreted as a departure from the scope of this disclosure.

Those skilled in the art will appreciate that the example system, devices, and methods can be used to transmit video data captured on a wireless device for display. The descriptions illustrate that video data can be transmitted for display such that live or nearly live display of the video data is possible. Such transmission may also make operation of the wireless device easier for a user of the wireless device, eliminating the need to periodically transmit video data to others for display and the need to delete video data to ensure continued availability of memory to store newly captured video data. This transmission for display can be used over any wireless network, even those with a low data rate and/or a high rate of data loss. The transmission may be implemented without specialized hardware, such as by using appropriate software. Even so, there are implementations that utilize specially designed hardware, such as integrated circuits or other devices or modules, and implementations which utilize a combination of software and hardware. Those skilled in the art will also realize other benefits and uses not expressly enumerated.

While the above detailed description has shown, described, and pointed out novel features as applied to various aspects, it will be understood that various omissions, substitutions, and changes in the form and details of the system, apparatuses, or methods illustrated may be made by those skilled in the art without departing from the scope of this disclosure. As will be recognized, the aspects and variations of the aspects may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

What is claimed is:

1. A method of transmitting video for display on a display device, the method comprising:
receiving a plurality of video segments from a wireless device, wherein each video segment comprises video data captured by the wireless device;
determining a data rate at which at least one of the plurality of video segments was received;
determining a delay based at least in part on the data rate at which at least one of the plurality of video segments was received;
waiting for a time approximately equivalent to the delay; and
transmitting for display on the display device the video segments in substantially the same order as the video segments were received,
wherein a size of the at least one video segment is determined based on at least one capability of the wireless device, and wherein transmitting a first video segment is executed while receiving or before receiving a last video segment.

2. The method of claim 1, wherein the wireless device is a mobile telephone.

3. The method of claim 1, further comprising:
storing the received plurality of video segments; and
concatenating the plurality of video segments into a single file capable of being displayed by the display device.

4. The method of claim 1, further comprising:
separating audio information in at least one of the received plurality of video segments from image information in the at least one video segment; and
converting the audio information and the image information to standard formats.

5. The method of claim 1, further comprising processing a series of individual images in at least one of the plurality of video segments into a video format.

6. The method of claim 1, further comprising appending a hint track to each of the plurality of video segments.

7. The method of claim 1, wherein the size of each video segment is a length of approximately 15-20 seconds of video data.

8. The method of claim 1, wherein the size of each video segment is a length of approximately 20 seconds of video data.

9. The method of claim 1, wherein the delay is reception of 3-5 files when the data rate is approximately greater than 150 kbps.

10. The method of claim 1, further comprising:
receiving a session ID of each of the video segments; and
storing video segments with corresponding session IDs in a common directory.

11. A method of transmitting video for display on a display device, the method comprising:
receiving a first video segment from a wireless device,
transmitting for display on the display device the first video segment;
receiving a second video segment from the wireless device before transmission of the first video segment is complete; and
transmitting for display on the display device the second video segment following completion of transmission of the first video segment,
wherein the first and second video segments comprise video data captured by the wireless device, wherein the size of the first video segment and the second video segment is determined based on at least one capability of the wireless device, and wherein less than all of the video data in the second video segment existed before the receiving of the first video segment is substantially complete.

12. The method of claim 11, wherein the wireless device is a mobile telephone.

13. The method of claim 11, wherein the size of the first and second video segments is a length of approximately 15-20 seconds of video data.

14. The method of claim 11, wherein the size of the first and second video segments is a length of approximately 20 seconds of video data.

15. A method of transmitting video from a wireless device, the method comprising:
determining a first video segment size based at least in part on a capability of the wireless device;
capturing a first video segment, the first video segment being of a size approximately equivalent to the determined first video segment size;
transmitting the first video segment to another device for display;
capturing a second video segment substantially simultaneously with the transmission of the first video segment; and
transmitting the second video segment to the other device for display following the transmission of the first video segment,
wherein the first and second video segments comprise video data.

16. The method of claim 15, wherein the wireless device is a mobile telephone.

17. The method of claim 15, wherein the determining is by reference to a table associating a model or type of the wireless device with the first video segment size.

18. The method of claim 15, wherein the second video segment is of a size approximately equivalent to the determined first video segment size.

19. The method of claim 18, wherein the first video segment size is a length of approximately 20 seconds of video data.

20. The method of claim 15, wherein the first video segment size and a size of the second video segment is a length of approximately 15-20 seconds of video data.

21. The method of claim 15, further comprising determining a second video segment size, wherein the second video segment is of a size approximately equivalent to the determined second video segment size.

22. The method of claim 15, wherein the capability of the wireless device is one of a speed of a processor of the wireless device, a resolution of a camera of the wireless device, and a bitrate at which a microphone of the wireless device is capable of capturing audio.

23. The method of claim 15, further comprising determining a session ID common to the first and second video segments.

24. The method of claim 15, wherein the determining the first video segment size comprises determining the first video segment size such that video data lost or delayed during the transmission the first video segment can be retransmitted before the wireless device finishes capturing the second video segment.

25. The method of claim 15, further comprising compressing the first and second video segments before the transmitting the first and second video segments.

26. The method of claim 15, wherein the capturing comprises capturing a series of individual images and a corresponding audio track.

27. The method of claim 26, wherein the wireless device is an iPhone™.

28. A system for transmitting video for display on a display device, comprising:
means for receiving a plurality of video segments from a wireless device, wherein each video segment comprises video data captured by the wireless device;
means for determining a data rate at which at least one of the plurality of video segments was received;
means for determining a delay based at least in part on the data rate at which at least one of the plurality of video segments was received; and
means for transmitting the video segments for display on the display device, after waiting for a time approximately equivalent to the delay, in substantially the same order as the video segments were received,
wherein a size of the at least one video segment is determined based on at least one capability of the wireless device, and wherein the transmitting means is configured to transmit a first video segment while the receiving means is receiving or before the receiving means is receiving a last video segment.

29. The system of claim 28, wherein the wireless device is a mobile telephone.

30. The system of claim 28, further comprising:
means for storing the received plurality of video segments; and
means for concatenating the plurality of video segments into a single file capable of being displayed by the display device.

31. The method system of claim 28, wherein the size of each video segment is a length of approximately 15-20 seconds of video data.

32. The system of claim 28, wherein the delay is reception of 3-5 files when the data rate is approximately greater than 150 kbps.

33. A wireless device for transmitting video, comprising:
a determination module configured to determine a first video segment size based at least in part on a capability of the wireless device;
a camera configured to capture video data;
a memory configured to store at least a first video segment of a size approximately equivalent to the first video segment size, wherein the video segment comprises captured video data;
a processor configured to store at least the first video segment and a second video segment obtained from captured video data in the memory; and
a transmitter configured to transmit the first video segment from the memory for display on another device, and the second video segment from the memory following transmission of the first video segment,
wherein the processor is further configured to store the second video segment in the memory while the transmitter is transmitting the first video segment.

34. The wireless device of claim 33, wherein the wireless device is a mobile telephone.

35. The wireless device of claim 33, wherein the determination module is configured to determine the first video segment size by reference to a table associating a model or type of the wireless device with the first video segment size.

36. The wireless device of claim 33, wherein the first video segment size and a size of the second video segment is a length of approximately 15-20 seconds of video data.
